(19) United States
(12) Patent Application Publication
(10) Pub. No.: US 2012/0267127 A1
(43) Pub. Date: Oct. 25, 2012

(54) Garden tool for planting starter plants, flower bulbs, ornamentals, shrubs seeds, and seedlings

(76) Inventor: John H. Arigoni, Clarksburg, MA (US)

(21) Appl. No.: 13/066,692

(22) Filed: Apr. 22, 2011

(51) Int. Cl. A01C 5/02; A01B 79/00

(52) U.S. Cl. 172/1; 172/22

(57) ABSTRACT

An improved easy to use lightweight multipurpose hand operated garden tool that allows the user to accomplish the task of planting of seeds, seedlings, bulbs, transplants and remove weeds or other unwanted material efficiently with an elongated, upright T handled shaft having a tubular cutter at the lower extremity thereof. An ejector plate freely passes through the cutter by means of an elongated rod extending upwardly through a guide and attached to a lever. The cutter is positioned over the area to be prepared and twisted back and forth and pushed into the soil define a plug of soil. The tool is then lifted from the soil, carrying with it the plug of soil. The lever is pushed downward causing the ejector plate to push and eject the plug of soil. The above process can be easily done through ground cover and weed barrier due to the beveled sharpen v-grooved edge of the cutter. This tool can also be used to take soil samples up to 3 inches deep per cycle of operation, and should remain sharp enough to cut up to 75 plugs and holes even if occasionally hitting a stone or two.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND FIELD OF INVENTION

Current U.S. Class: 2/371; 172/22; 172/41; 172/532; 175/385

Current International Class: 1B 1/00 (20060101); A01B 1/06 (20060101); A01C 00 (20060101); A01C 5/04 (20060101); A01B 001/00

Field of Search: 172/19,21,22,25,41,111,418,532,371; 175/385,394; 111/106

### REFERENCES CITED

U.S. PATENT DOCUMENTS

| | | | |
|---|---|---|---|
| 6,352,122 | Mar. 5, 2002 | Love | 172/371; 172/22; 172/41; 172/532; 175/385 |
| 6,662,879 | Dec. 16, 2003 | Costa | 172/2; 175/20; 294/50.7; 30/316 |
| 6,612,379 | Sept. 2, 2003 | Timmons | 172/375; 172/381; 294/55; D8/107; |
| | | | D8/315; D8/315; D8/98 |
| 4,585,072 | Apr. 29, 1986 | Martinez | 172/22; 111/106; 294/50; 294/50.7 |

“The present invention relates to hand held and operated gardening tools, more specifically to improve and expand the scope and function of the simple hand tool addressing the issues of ease of use, reduction of labor intensive planting, and the ability to make ready the tilled or unfilled ground for planting of seeds, starter plants or bulbs with or without use ground covers or weed barriers.”

### DISCUSSION OF PRIOR ART

Hand gardening tools such as shovels, rakes, bulb planters, tillers and the like have been used in some form for as long as man started to plant his food. As with all man made things these tools are constantly being improved on or new inventions made to deal with the rising needs of the gardener or farming industry.

Generally, hand gardening tools are made with a handle, a shaft, and either a set of tongs, spade, forks, or blade of circular shape designed to work the soil and make the ground ready for the planting.

Typically these garden hand tools work fairly well but have several drawbacks that lead to excessive bending and crouching close to the ground. These drawbacks result in a myriad of problems from back aches to tendonitis, arthritis and blisters on knees and hands depending on the time spent operating said tools.

To address these issues inventors and developers started to make specialty tools for making planting easier and faster such as the garden tool for planting flower bulbs and ornamentals, U.S. Pat. No. 6,352,122 of LOVE, which utilizes an elongated shaft with a boring bit with a pair of fins to make and widen the planting hole while breaking up the soil, the operating end being driven by a drill. Though this device does the job it will not cut through ground cover and puts a lot of stress on the operator, while requiring a power cord or battery operated drill needing charging.

A similar planting tool is the semi automatic garden planter, U.S. Pat. No. 6,662,879 of Costa, which utilizes an elongated shaft with a foot operated plunger by means of a foot rest used to thrust the plunger into the soil and a second plunger and a set of plunger plates that are settable for the depth of the hole. This device uses a spring loaded mechanism to hold and release the soil during operation. Again the device does the job however it to does not permit cutting ground cover due to the serrated cutting tip and requires the operator to do multiple function operations in order to make a hole in the ground. It is believed that the closest of the prior art references to instant invention is this patent to Costa U.S. Pat. No. 6,662,879

A different approach to garden planting is the multipurpose gardening tool U.S. Pat. No. 6,612,379 of Timmons, which uses a double edged scoop base that is v shaped, one end of said scoop is adapted to dig into, scoop up and remove soil or other material while the other end of said scoop has a sharp jagged edge for cutting into roots and such. This gardening tool requires digging and cutting or soil and roots and though it may give plantability it does not allow for precision hole planting or clean cutting of ground covers.

A close cousin to the instant invention would be the Gardening tool with plug ejector and detachable cutting chamber U.S. Pat. No. 4,585,072 of Martinez. This approach shows a central shaft type ejector and cutter plug puller and is designed to pull weeds but would not be able to cut ground cover in its current design.

A further search of the prior art has uncovered the following patents: Price, U.S. Pat. No. 4,986,588; Deane, U.S. Pat. No. 1,692,436; Rose, U.S. Pat. No. 2,531,297; Hus, U.S. Pat. No. 6,349,776; Ballmann, U.S. Pat. No. 3,444,938; Glynn, U.S. Pat. No. 3,210,112; Ober, U.S. Pat. No. 1,783,026; List, U.S. Pat. No. 4,932,339; Hoffman, U.S. Pat. No. 4,884,638; and Gottfried, U.S. Pat. No. 3,273,930.

No single reference cited above and found during my search discloses all of the features of the instant invention, although some of these prior art references do disclose some, but not all, of the elements of the instant invention.

### SUMMARY OF THE INVENTION

Accordingly, the reader will see in FIG. 1 of the instant invention, a gardening hand tool that resembles a pogo stick, comprising a T handled vertical shaft of tubular construction with an offset larger diameter shorter tube affixed to the lower extreme wherein is affixed to a threaded rod a flat circular metal plate of slightly smaller diameter. Said threaded rod extends vertically upward parallel to the T handle shaft through a guide affixed to said T handle shaft and attached at its upper end to a movable lever also attached to said T handle shaft aligned with said larger diameter cutting tube at a 90 degree angle to said T. The user places the lower end on the ground and by twisting the T handle and pushing downward causes the cutting edge to sink into the ground thereby cutting a plug of soil the diameter of the cutting tube. The user then lifts the tool up out of the ground and presses the lever to eject the plug and is ready to move to the next hole actually making the job easier done than said.

### OBJECTS AND ADVANTAGES

Being designed to address the gardeners and landscapers needs that have been discussed with the prior art, several additional objects and advantages of the present invention are:
(a) to provide an easy to use lightweight tool that allows the user to accomplish the task of planting of seeds, bulbs, transplants and remove weeds or other unwanted material efficiently;
(b) to provide a means of gardening through a ground cover without having to bend down or kneel to cut said ground cover with the usual cross cut with a knife;
(c) to provide a means of gardening that is less time consuming and less stressful on the gardener;
(d) to provide a means of extracting a plug of soil in the correct diameter to facilitate the root base of a transplant in the most efficient manner possible;

These and further objects, features and advantages of the invention shall become apparent from the following detailed description of a preferred embodiment thereof when taken in conjunction with the drawings, wherein like reference characters refer to corresponding parts in the several views.

### BRIEF DESCRIPTION OF SEVERAL VIEWS OF THE DRAWING

The present invention will be better understood from the following detailed description as depicted in the several views of drawings in which like referenced numerals refer to like parts;

FIG. 1 is a vertical front plan view of the invention in its assembled position, extending a bottom view of the business end;

FIG. 2 is an exploded vertical side view of the device shown in FIG. 1, depicting broken line disclosure of the lower end;

FIG. 2A is a bottom view of the ejector lever;

FIG. 2B is a top view of the ejector rod guide;

FIG. 3 is a vertical view of a two part attachment;

FIGS. 4 TO 4C are cross sectional views of the cutter tube, ejector plate, and ejector rod, with ejector rod and ejector plate in various positions during the inventions operation.

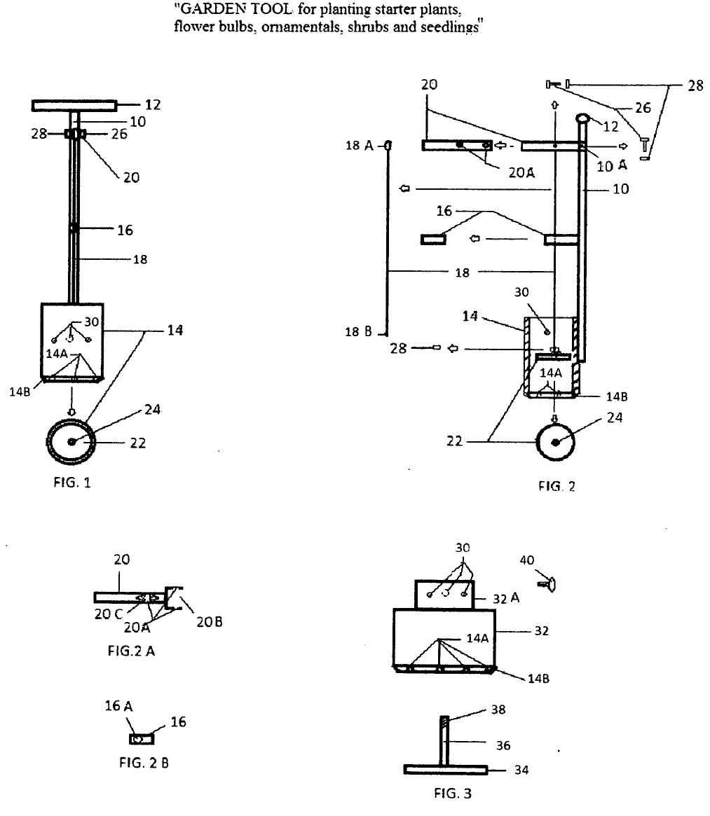

The broken lines shown in FIGS. 1-3 are for illustrative purposes only and form no part of the claimed design.

### DETAILED DESCRIPTION OF THE INVENTION

The following description is provided to enable any person skilled in the art to make and use the invention and sets forth the best modes contemplated by the inventor for those so skilled to do so.

FIG. 1 is a vertical front plan view of the invention in its assembled position, extending a bottom view, comprised of a main shaft 10 of tubular material, affixed thereto by well known means at the upper end is a T handle 12 of similar material, at the lower end is affixed by similar means a cutter tube 14. Said cutter tube is v grooved 14A, and is beveled inward and sharpened 14B at its lower most edge, in addition the cutter tube is equipped with attachment mounting holes 30. At the center of the main shaft 10 is affixed by the same means an ejector rod guide 16, in which is made an ejector rod guide hole 16A.

Also shown in FIG. 1 attached by removable means consisting of standard bolts 26, and standard nuts 28, is an ejector rod 18, comprised with an ejector rod hole 18A, at its upper most end to an ejector rod lever 20, and is threaded 18B, at its lower most end and affixed by similar removable means within said cutter tube 14, to an ejector plate 22, by means of a threaded hole 24, in said ejector plate 22, and locked in place by said standard nut 28.

FIG. 2 is an exploded vertical side view of the device shown in FIG. 1, depicting broken line disclosure of the lower end to further clarify the correlation and attachment of said ejector rod 18, ejector lever 20 and ejector plate 22 to the main shaft 10, by means of the main shaft lever mounting hole 10A, illustrating the mid position of both ejector lever 20 and ejector plate 22 and illustrates the placement of the ejector rod 18 through the ejector rod guide 16 while disclosing the position of the ejector lever bolt holes 20A.

FIG. 2A is a bottom view of the ejector lever 20, better clarifying the location of the ejector lever bolt holes 20A, and further illustrates the attachability to the main shaft 10, by means of an ejector lever flange 20B, which fits over the main shaft 10, through which a standard bolt 26, is placed and fastened with a standard nut 28. FIG. 2A also illustrates the position of the ejector lever slot 20C, through which the ejector rod hole 18A, is placed for fastening with a standard bolt 26, is placed and fastened with a standard nut 28.

FIG. 2B is both a top and bottom view of the ejector rod guide 16, showing the location of the ejector rod guide hole 16A, through which the ejector rod 18, is guided during operation.

FIG. 3 is an exploded front vertical view of a removable mountable large diameter cutter head 32, attachment ejector plate 34, and the attachment ejector rod 36.

The large diameter cutter head 32, is made of a larger size tubing than the cutter tube 14, and is permanently affixed by well known means to a large diameter cutter head mount 32A, the inside diameter of said mount is snugly fit over the outside diameter of the cutter tube 14, while the attachment mounting holes 30, are aligned and fastened by means of the attachment wing bolts 40, of which there are three spaced at 120 degrees around the perimeter of the mating surfaces.

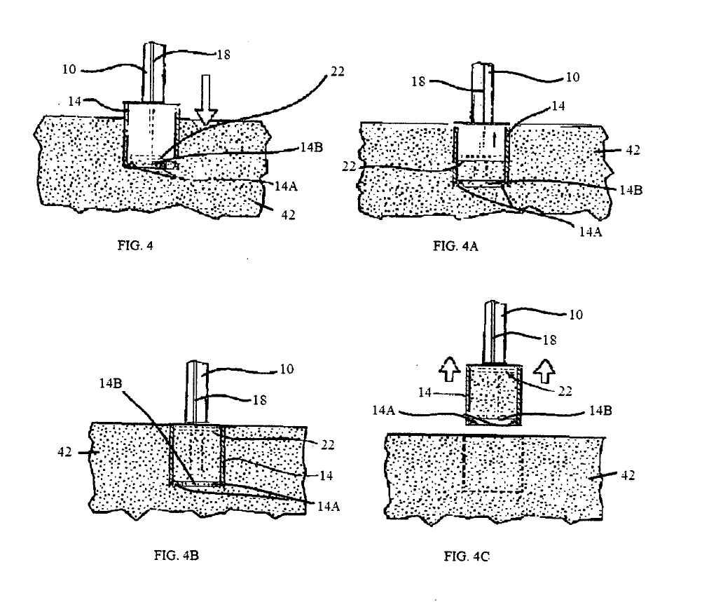

FIGS. 4, 4A, 4B, and 4C are cross sectional views of the cutter tube, ejector plate, and ejector rod, with ejector rod and ejector plate in various positions during the inventions operation.

What I claim to be secured by Letters Patent of the United States is:

1. A T handled gardening tool for cutting through ground cover, sod, tilled soil, and removing soil plugs from the ground preparatory to planting bulbs, vegetables, seedlings and seeds with an ejector system to dispense said plug comprising:
a tubular vertical main shaft means with a centered horizontal hole towards the upper end to which all parts are attached;
a tubular horizontal shaft forming a T handle means for griping the tool at the top of said vertical shaft aligned with said horizontal hole in the vertical shaft;
a short tubular cutter means v grooved and beveled sharp inward at its lower most edge affixed to the lower end of said tubular vertical shaft at a 90 degree angle to said tubular horizontal shaft;
a short tubular guide means permanently affixed to the center of said tubular vertical shaft at the same 90 degree angle as said tubular cutter with a vertical guide hole centered above the center of said tubular cutter;
a means to eject soil plugs;
a large attachment cutter means to cut and eject larger diameter soil plugs;
a means to removeably attach said large cutter and ejector;

2. The T handled gardening tool for cutting through ground cover, sod, tilled soil, and removing soil plugs from the ground preparatory to planting bulbs, vegetables, seedlings and seeds with an ejector system to dispense said plug of claim 1 wherein said ejector means comprising;
a ejector rod means for pushing, centered through ejector rod guide;
a hole means for removeable connection at the top of said ejector rod;
a thread means for removeable connection at the bottom of said ejector rod;
a lever means with removeable connection at the top of said ejector rod and main shaft;
a ejector plate means with removeable connection at the bottom of said ejector rod and free floating within the cutter tube for ejection;
a removeable connection of the ejector assembly parts is by means of standard bolts and nuts of appropriate size and dimension;

3. The T handled gardening tool for cutting through ground cover, sod, tilled soil, and removing soil plugs from the ground preparatory to planting bulbs, vegetables, seedlings and seeds with an ejector system to dispense said plug of claim 1 wherein said large attachment cutter means to cut and eject larger diameter soil plugs comprising;
a larger diameter tubing cutter head means v grooved and beveled sharp inward at its lower most edge, while the upper most end is snugly affixed to the lower end of said short tubular cutter of claim 1 by means of a large attachment head mount;
an arrangement of three self tapping wing bolt placed at equal spaces around the parameter means to lock said large attachment head mount tube in place;
a attachment ejector plate means to eject the larger plug;
a attachment ejector rod means, threaded to receive the threaded end of the ejector rod of claim 2;
Whereby the operator, will grip the assembled T handled gardening tool for cutting through ground cover, sod, tilled soil, and removing soil plugs from the ground preparatory to planting bulbs, vegetables, seedlings and seeds with an ejector system to dispense said plug of claim Twill place the cutter end on the area which is to be cut out and twist while pushing downward causing the cutter to penetrate ground, cut ground cover and form a plug of soil within the cutter which caused the ejector handle to move from the down position to the up position The operator then lifts the tool by the T handle and ejects the plug by moving the ejector handle from the up position to the down position. To make a larger soil plugs and holes the operator will loosen the nut above the ejector plate in the cutter tube affixed to the main shaft and remove the ejector plate from inside said cutter tube. Next the operator will fit the larger cutter head attachment over the fixed cutter tube and faster it with the three self tapping wing bolts. Now the operator will put the larger cutting attachment ejector plate with attachment threaded ejector rod end up, thread it to the ejector and lock it in place by tightening the nut against the attachment ejector rod. Now the operator is ready to make larger plugs and holes. Any size adapter can be used within reason and an adapter plate can be made with a center hole and dimples to hold ground in place and prevent pulling with larger diameter cutting attachments, which the operator would place on the ground cover dimple side down and place the cutter for operation within the center hole while stepping on said plate to hold it in place.
